(19) United States
(12) Patent Application Publication
(10) Pub. No.: US 2006/0072925 A1
(43) Pub. Date: Apr. 6, 2006

(54) Circuit arrangement for electrically isolated transmission of an electrical signal with an optocoupler

(76) Inventor: Hartmut B. Brinkhus, Heidelberg (DE)

Correspondence Address: SENNIGER POWERS, ONE METROPOLITAN SQUARE, 16TH FLOOR, ST LOUIS, MO, 63102, US

(21) Appl. No.: 11/243,721

(22) Filed: Oct. 5, 2005

(30) Foreign Application Priority Data
Oct. 5, 2004 (DE) 10 2004 049 016.3

(51) Int. Cl. H04B 10/04; H04B 10/12

(52) U.S. Cl. 398/189

(57) ABSTRACT

A circuit arrangement for electrically isolated transmission of an electrical signal with an optocoupler comprising a converter circuit which converts the electrical signal into a pulse width-modulated signal and delivers this signal to an optocoupler; a logic circuit which generates a completion signal when the conversion into the pulse width-modulated signal has been completely finished; an evaluation circuit connected to the output of the optocoupler which recognizes the pulse width-modulated signal as valid only when the completion signal has been received by it. Conversion into the pulse width-modulated signal is performed after the appearance of the electrical signal to be converted only after a delay time (tᵥ) has elapsed. The power supply of the circuit arrangement is realized on the input side of the optocoupler by means of a power supply circuit, which is powered by the electrical signal to be converted.

### REFERENCE TO RELATED APPLICATION

This application claims priority from German patent application 10 2004 049 016.3 filed Oct. 5, 2004.

### FIELD OF THE INVENTION

The invention relates to a circuit arrangement for electrically isolated transmission of an electrical signal with an optocoupler.

### BACKGROUND

DE 102 51 504 A1 describes a device for transmitting digital signals by means of an optocoupler. The digital signals are pulse-width modulated. An edge module connected before the optocoupler generates an edge signal, whose edge pulses are in sync with the edges of the input signal. This edge signal is transmitted by means of the optocoupler, on whose output side, an output signal having the same pulse-width condition as the input signal, is generated, in turn, from the edge signal.

From DE 3026988 A1 and DE 2947770 A1, it is known to mark pulse width-modulated signals by means of higher-order frame-multiplexed signals.

Optocouplers are used in many applications for electrically isolated signal transmission. Also electrically isolated digital inputs, like those frequently required in processing technology, usually use optocouplers for electrical isolation. For digital inputs, here, the digital switching thresholds are defined by the selection of a suitable optocoupler and by the size of a protective resistor connected in series. However, for digital processing technology, it would be desirable for the turn-on and turn-off thresholds to be programmable if possible. Programmable thresholds have the advantage that processing input/output devices can be adapted to different conditions with such thresholds. In practice, namely for digital inputs and outputs, there is still no worldwide standard level for a logical zero and a logical one. A certain standard has been developed, namely <5 V as a logical zero and >13 V as a logical one, however, the region between 5 V and 13 V is undefined. Therefore, in practice, the adaptation for different thresholds is done in hardware, which then requires different product variants. Incidentally, previously used circuits are also relatively imprecise, because the transmission characteristics of optocouplers are strongly dependent on temperature.

### SUMMARY OF THE INVENTION

Therefore, among the various features of the invention are improvements to the circuit arrangement of the type named above to the extent that an electrical signal can be transmitted electrically isolated by means of an optocoupler and here switching thresholds for a downstream signal processing circuit can be freely programmed.

Briefly, therefore, the invention is directed to a circuit arrangement for electrically isolated transmission of an electrical signal with an optocoupler comprising a converter circuit which is connected to an input side of the optocoupler and which converts an electrical signal into a pulse width-modulated signal and supplies said pulse width-modulated signal to the optocoupler; a logic circuit which generates a completion signal and delivers said completion signal to the optocoupler when the conversion into the pulse width-modulated signal has completely finished; and an evaluation circuit which is connected to the output side of the optocoupler and which recognizes the pulse width-modulated signal as valid only when the completion signal has been received.

Other aspects and features of the invention are in part apparent and in part pointed out hereinafter.

### BRIEF DESCRIPTION OF THE FIGURES

FIG. 1, a block circuit diagram of a circuit arrangement according to the invention;

FIGS. 2a-2e, different diagrams of the time profile of the input and output voltage of the circuit arrangement;

FIG. 3, a diagram of the time profile of the input and output voltage with output signal inverted relative to FIG. 2; and

FIG. 4, a flow chart of the evaluation of the output signal of the optocoupler.

### DETAILED DESCRIPTION OF PREFERRED EMBODIMENTS

This application claims priority from German patent application 10 2004 049 016.3 filed Oct. 5, 2004, the entire disclosure of which is expressly incorporated herein by reference.

The basic principle of the invention is to transfer the value of an input voltage by pulse-width modulation by means of the optocoupler and to generate and transmit a completion signal after complete transmission of the pulse width-modulated signal. An evaluation circuit connected to the optocoupler on the output side interprets the received pulse width-modulated signal as valid only when the completion signal has been transmitted. In principle, the evaluation is performed by measuring the pulse width of the modulated signal, by means of which, the magnitude of the voltage applied to the input side can be reconstructed on the output side of the optocoupler. This voltage can be compared with preprogrammed values, by means of which the desired freely programmable switching thresholds are also realized.

Because the input signal appears for an unknown time period in processing technology, it is possible for the input signal to disappear before the pulse width encoding has been completed. Then a pulse edge would appear at the output of the optocoupler. So that this is not confused with the end of a complete pulse width-encoded signal, a completion signal is provided, which unambiguously identifies the complete pulse-width encoding. This completion signal is, for example, a double pulse with a predetermined period for the pulse and for the pause between the pulses. Because a new useful signal (e.g., with logical “1”) can appear immediately after the end of one useful signal, for unambiguous differentiation of the useful pulse width-modulated signal from the completion signal, it is further provided that the pulse-width modulation begins only after a predetermined wait time, wherein this wait time begins with the appearance or turn-on of the signal to be transmitted.

According to an advantageous improvement of the invention, the circuit arrangement is supplied with power on the input side of the optocoupler by the useful signal itself.

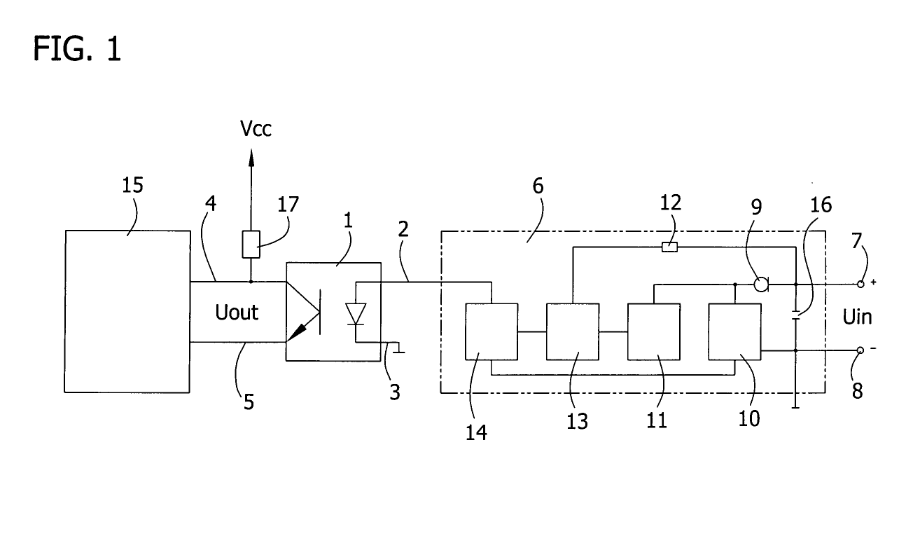

First, FIG. 1 will be referenced. The circuit arrangement contains a commercially available optocoupler 1 with input connections 2 and 3 and also output connections 4 and 5, wherein the input connections 2 and 3 are electrically insulated from the output connections 4 and 5. The input connection 3 is connected to ground, while the input connection 2 is connected to an output of a circuit arrangement 6, which has input connections 7 and 8 for the electrical signal to be transmitted and named “wanted signal” below. The input connection 8 is connected to ground, while the input connection 7 is connected via a constant current diode 9 to a power supply unit 10 and a start identification circuit 11 and also via a resistor 12 to a converter circuit 13, which converts the voltage Uᵢₙ of the wanted signal applied to the connections 7 and 8 into a pulse width-modulated signal and forwards this signal to a logic circuit 14, which generates the input signal for the optocoupler 1. The power supply unit 10 powers the start identification circuit 11, the converter circuit 13, and the logic circuit 14 with electrical energy, which is obtained from the useful signal.

The output signal of the circuit arrangement 6 is transmitted by means of the optocoupler 1 to an evaluation circuit 15, which determines the pulse width of the received signal, for example, with a counter or an integrator, and from this value generates a preferably digital signal, which corresponds to the voltage of the wanted signal. The output connection 4 of the optocoupler 1 is connected to power supply voltage V_{cc} via a resistor 17, so that the output connection 4 is at a high voltage level for a logical zero and at a low voltage level for a logical one.

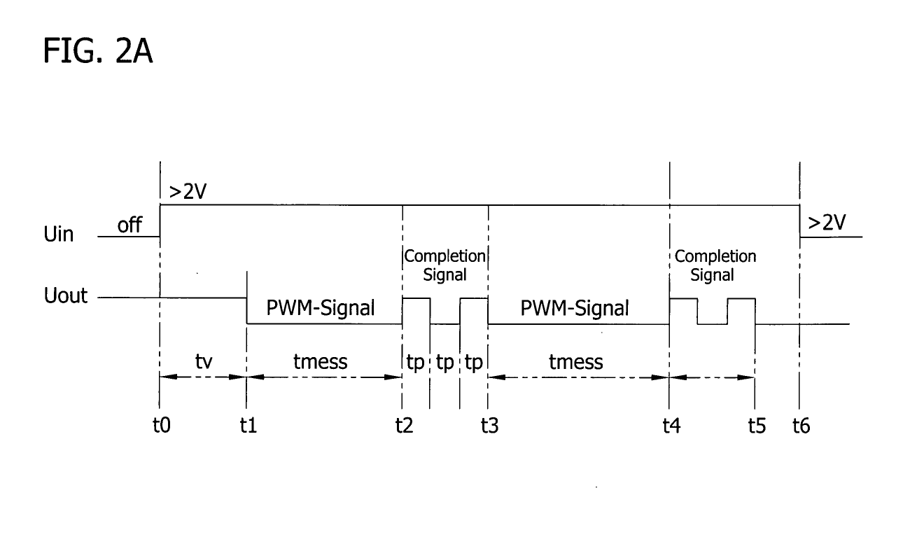

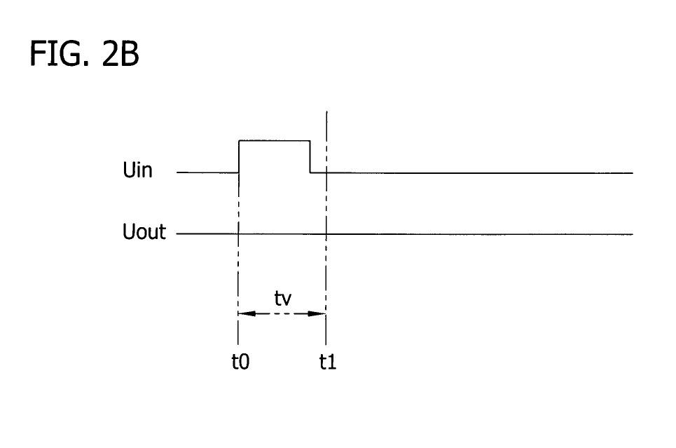

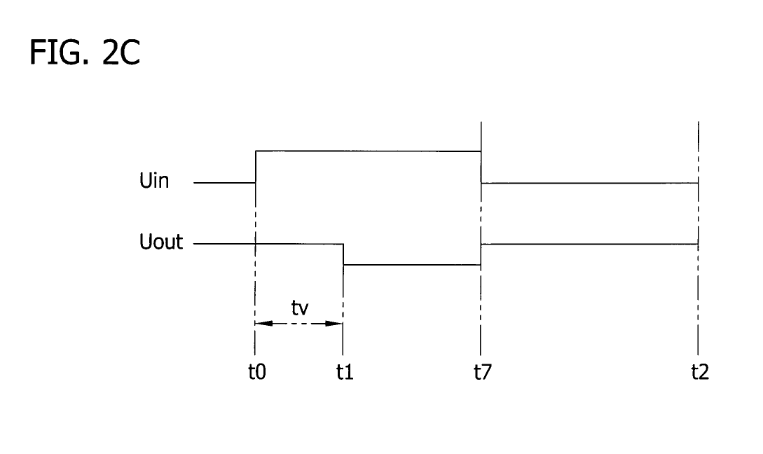

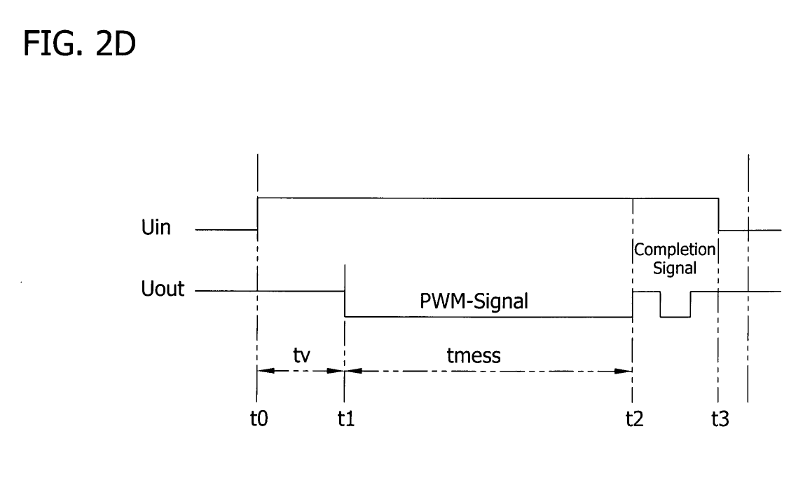

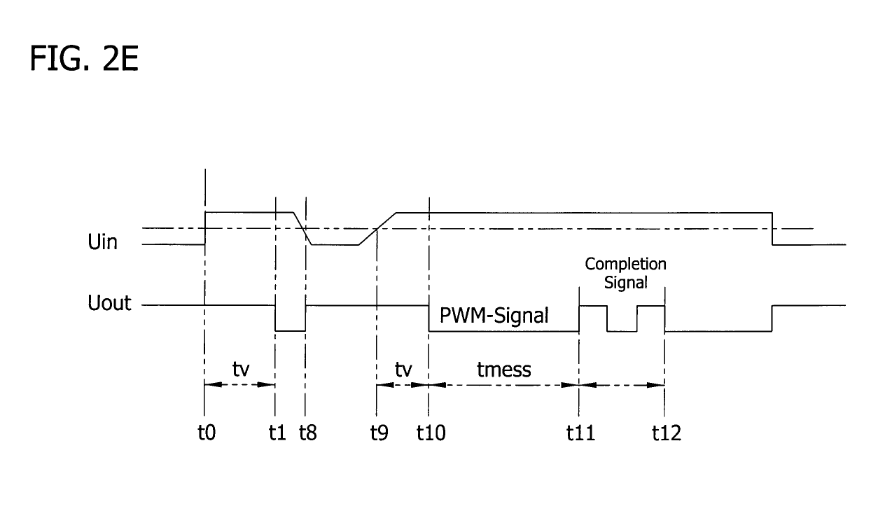

The action of the circuit arrangement of FIG. 1 is explained in connection with FIG. 2. It shall be assumed that all components of the circuit arrangement 6 require a working voltage of at least 2 V and that the wanted signal is essentially constant during its period. In FIG. 2a, it is assumed that the wanted signal Uᵢₙ>2 V and is turned on at time t₀. With a delay time tᵥ of a predetermined constant length, the start identification circuit 11 turns on the converter circuit 13, which generates a pulse width-modulated signal Uₒᵤₜ beginning at time t₁ after the delay time tᵥ has elapsed. This appears as a negative pulse for a time period tₘₑₛₛ and is output to the optocoupler 1 via the logic circuit 14. The time period tₘₑₛₛ is a function of the voltage Uᵢₙ, for example, and is directly proportional to this voltage. After the measurement time tₘₑₛₛ has elapsed at time t₂, the logic circuit 14 generates the completion signal, which here is a double pulse with predetermined time period and predetermined pulse/pause ratio, which ends at time t₃. For the logic system used here, the completion signal is first at a logical “1” for a time period tₚ, then at logical zero for the same time period tₚ, and then at logical one again for the same time period tₚ and then it falls back again to logical zero at time t₃. Because the voltage Uᵢₙ at this time t₃ is still at full magnitude, a new measurement process begins at the measurement time tₘₑₛₛ, so that in the time period t₄-t₅ a negative pulse appears again, which, in turn, is completed by a double pulse with the length of three times tₚ in the time period t₄-t₅. At time t₅ a new measurement process begins, which, however, is not completed, because at time t₆ the wanted signal disappears, so that no double pulse is transmitted.

In FIG. 2b, the case is shown in which the wanted signal Uᵢₙ is applied for a time that is shorter than the delay time tᵥ. Therefore output signal Uₒᵤₜ is constant and has absolutely no pulses.

FIG. 2c shows the case in which the wanted signal Uᵢₙ is applied for a time that is longer than the delay time tᵥ, but ends at a time t₇, at which the time period t₁-t₇ is shorter than the measurement time tₘₑₛₛ of t₁-t₂. Then, a negative pulse, which, however, ends at time t₇ with the disappearance of the wanted signal Uᵢₙ, appears at time t₁, so that no double pulse is generated. Therefore, the evaluation circuit 15 interprets the pulse width-modulated signal Uₒᵤₜ as invalid due to the absence of the completion signal.

FIG. 2d shows the case in which the wanted signal Uᵢₙ is applied for a sufficient length and ends just at the time t₃, i.e., at the end of the completion signal. The completion signal generated by the logic circuit 14 has two rising and two falling edges, which are continuously constrained by the logic used here. At the time of the second positive (rising) edge of the completion signal (t₂+2×tₚ), the measurement can already be labeled as valid.

FIG. 2e shows the case in which the wanted signal Uᵢₙ falls under the response threshold (for example, of 2 V) in the time period of t₈-t₉. After the delay time tᵥ has elapsed, a negative pulse, which, however, ends at time t₈, appears on the output signal Uₒᵤₜ, because at this time the signal falls below the threshold of 2 V. At time t₉, when the wanted signal Uᵢₙ has again risen over the mentioned threshold, a new delay time tᵥ begins, which ends at time t₁₀, so that the signal Uₒᵤₜ returns to logical zero. Then the measurement time tₘₑₛₛ follows in time period t₁₀-t₁₁, at which, in turn, a correct double pulse with a length three times tₚ appears in the time period t₁₁-t₁₂.

In summary, the circuit arrangement fulfills the following functions:

Because the circuit is to be powered from the wanted signal Uᵢₙ, the circuit arrangement 6 becomes operational only when a level greater than about 2 V is applied. By the start identification circuit 11, an unambiguous, defined start condition is defined, namely that the input level of Uᵢₙ must be greater than a predetermined value (such as, e.g., the mentioned 2 V). Here, the power supply 10 ensures that the wanted signal, which can lie, e.g., between 2 V and 80 V, provides a power-supply voltage for the circuit arrangement 6. If the wanted signal Uᵢₙ rises over this value, then the optocoupler 1 turns on after a delay time tᵥ and the output signal Uₒᵤₜ of the optocoupler goes to logical zero, which is the start condition for the evaluation circuit 15. After a certain time, namely the measurement time tₘₑₛₛ, which corresponds to the magnitude of the voltage Uᵢₙ of the wanted signal, the light-emitting diode of the optocoupler 1 is turned off twice momentarily, which is interpreted as a completion signal for a complete conversion process by the converter 13. Then, in turn, a new measurement begins.

Because the wanted signal can fall below the predetermined value of; e.g., 2 V, at any time, which can make the circuit arrangement 6 inactive and turns off the light-emitting diode of the optocoupler 1, it must be ensured that this state can be differentiated from the “normal” end of a voltage measurement, i.e., the end of the pulse width.

This is achieved in that for a continuously applied input level Uᵢₙ>2 V, the end of the pulse is indicated by two additional, short pulses with a pulse pause in-between. If a following pulse appears after the end pulse, then the previous result for the measurement of the pulse width is labeled as valid. If the following pulse does not appear within a predetermined time period, this means that the input voltage has fallen below the value for the fault-free operation of the circuit, i.e., the end of the pulse was caused by a change in the state of the input signal to logical zero. The currently running measurement of the pulse width is then interpreted as invalid.

If the input voltage Uᵢₙ lies below the voltage at which the circuit begins to operate, then the diode of the optocoupler does not carry a current. If this state lasts longer than the longest measurable pulse width, this is interpreted as a logical zero by the evaluation circuit 6. If the input voltage rises above the predetermined value of, for example, 2 V, then the LED of the optocoupler is turned on after a delay tᵥ and remains turned on for the period tₘₑₛₛ. If the input voltage rises to the maximum of the value to be processed with the circuit, which lies, for example, at 80 V, tₘₑₛₛ falls to the shortest frequency that can be transmitted with the optocoupler that is used. Because the conversion of the voltage is integrated in the pulse width, fluctuating input voltages are also measured and transmitted correctly. In principle, a time-weighted average value is formed.

The circuit arrangement can also differentiate, as explained in connection with FIGS. 2a-2e, the following cases.

The input voltage Uᵢₙ rises above the response threshold of for example, 2 V, but then always remains above this value.

Also, fault monitoring, for example, for a chip at too high a temperature, is possible, which can be indicated by one or more additional pulses transmitted, for example, between the end and the following pulse.

In principle, the evaluation circuit 15 works with a counter, which is clocked by an oscillator and counts the pulses delivered by the oscillator during the measurement period tₘₑₛₛ. The frequency of the oscillator thus determines the possible resolution. If the counting pulses, for example, have a period of 30 ns and if the maximum measurement time tₘₑₛₛ for a wanted signal of 80 V=100 μs, then a resolution of the voltage to be measured of 27 mV is obtained.

A change of the wanted signal from logical one to logical zero can be recognized by the evaluation circuit with certainty only by the lack of the end pulse after the maximum pulse period to be measured has elapsed, thus, only after 100 μs.

If one wants to shorten this reaction time, then this can be realized at the expense of the resolution. If the maximum measurement period tₘₑₛₛ is shortened to 10 μs, then one obtains for time pulses of 30 ns a resolution of 270 mV, which is still sufficient for most typical applications.

A change of the wanted signal from logical zero to logical one is recognized by the evaluation circuit after the delay time tᵥ has elapsed. Instead, one could also actively generate an encoded pulse sequence of one or more pulses with a predetermined period of, for example 100 ns, which is recognized by the evaluation circuit and indicates the beginning of the measurement phase.

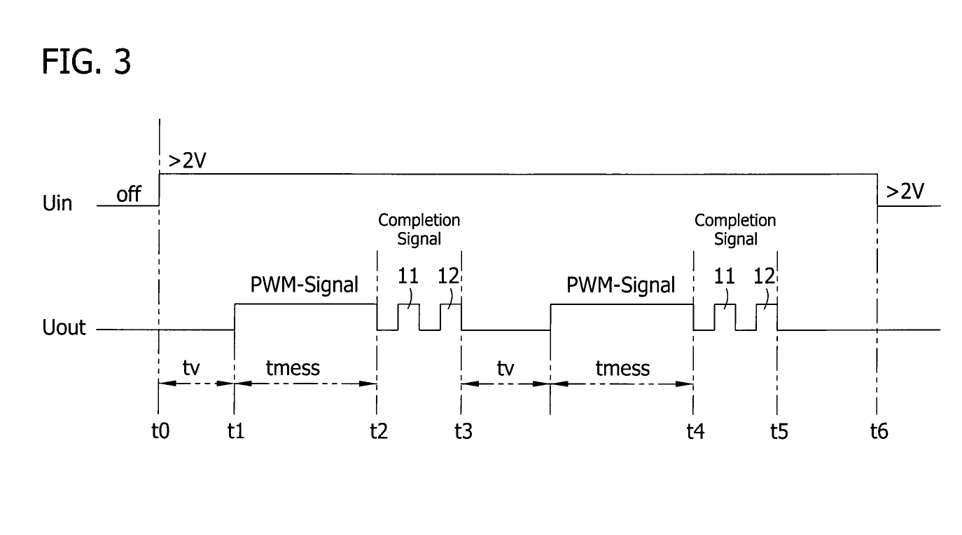

Similar to FIG. 2a, FIG. 3 shows a diagram of the input voltage Uᵢₙ and the output voltage Uₒᵤₜ, wherein the latter is inverted relative to FIG. 2a. Instead of the resistor 17 shown in FIG. 1, to which the optocoupler is connected as an emitter follower, then in a known way another resistor is used, which is connected in a known way so that for a conductive transistor of the optocoupler 1, the corresponding output connection goes to a high voltage level.

Thus, after the end of the measurement time, the output signal Uₒᵤₜ goes to the low level (logical zero) at time t₂ and a double pulse follows with the pulses I₁ and I₂, which ends at time t₃. In the same way, a new measurement process follows with delay time tᵥ, measurement time tₘₑₛₛ, and a completion signal.

It can be further seen from FIG. 3 that the completion signal can also be formed by a single complete pulse. At the end of the measurement time tₘₑₛₛ, Uₒᵤₜ falls to a low level, which is recognized by the falling edge. Another complete pulse I₁ with a falling edge could then be sufficient for verification.

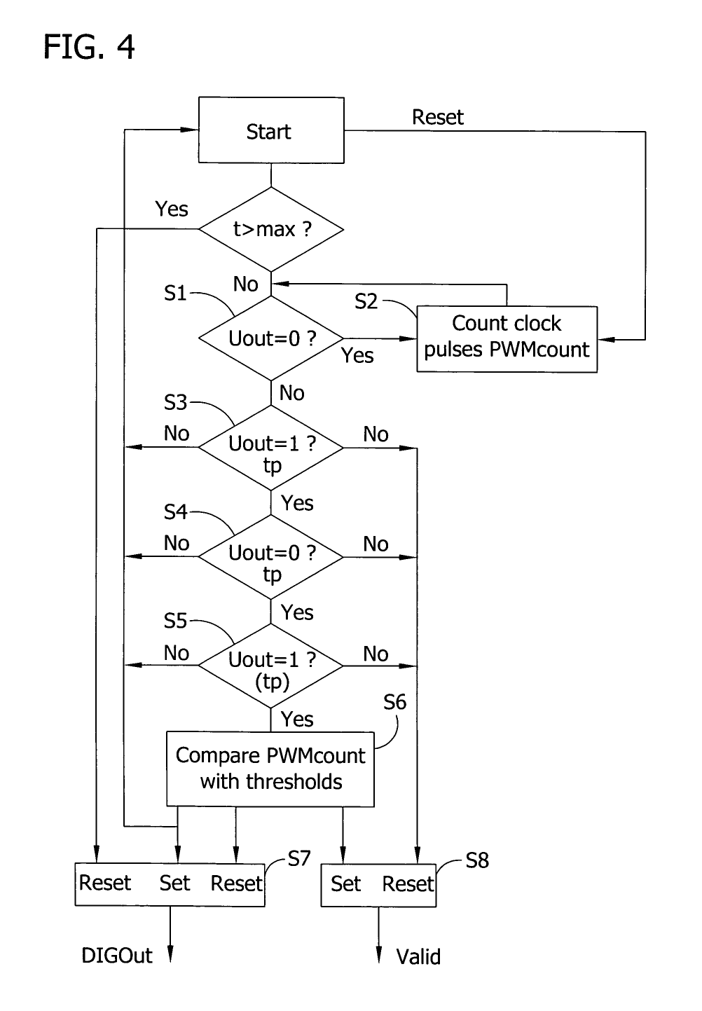

FIG. 4 shows a flow chart for explaining the function of the evaluation circuit 15. After the monitoring starts, the time period t, within which a measurement signal must appear, is monitored. This time period is shorter than the maximum pulse width of the measurement time, thus, for example, shorter than 100 μs. If no signal appears within this time period, thus, if t is greater than tₘₐₓ, then a reset signal is delivered to a digital output S7. In contrast, if a signal Uₒᵤₜ output from the optocoupler 1 to the outputs 4 and 5 appears, then after the wait time tᵥ has elapsed (FIG. 2a), Uᵢₙ goes to logical zero, which is monitored continuously in step S1. If this is the case (Uₒᵤₜ=0), then the number of clock pulses of a not shown clock generator is counted continuously in a counter, whose count contents are designated by “PWMcount” (cf. block S2).

The counting ends as soon as Uₒᵤₜ goes to logical one. Then the evaluation of the completion signal follows. In block S3, whether Uₒᵤₜ remains at logical one for a predetermined time period tₚ, which corresponds to the width of a completion pulse of, for example, 100 ns, is monitored. If this is not the case, then the measurement is rejected as invalid and the value PWM_{count} is reset to zero and a signal “Valid” is reset in block S8, which means that there is no valid measurement signal. In contrast, if this is the case, then in block S4, it is monitored whether a pulse pause follows the length tₚ, thus whether Uₒᵤₜ remains at logical zero for the period tₚ. If this is not the case, then, in turn, the evaluation is interrupted, PWM_{count} is reset to zero, and the signal “Valid” in block S8 is also reset to zero. In contrast, if this is the case, then in block S5 it is tested whether the second pulse of the completion signal has come, thus, whether Uₒᵤₜ goes to one for the period tₚ. In principle, it is sufficient here to monitor the change of Uₒᵤₜ from zero to one, thus, the positive edge. If the positive edge or the second pulse of the completion signal is recognized, then the count contents PWM_{count} are interpreted as valid and can be compared with the predetermined thresholds (block S6). If this is not the case, then the signal “Valid” is also reset to zero in block S8. Depending on the mentioned comparison, an output signal DIGₒᵤₜ is output by signals “Set” and “Reset” to the block S7. For example, if the count value PWM_{count} is greater than an upper threshold, then DIGₒᵤₜ is at logical zero, i.e., a signal is output to the reset input of the block S7. If it is smaller than a lower threshold, then DIGₒᵤₜ is at logical one, i.e., a signal is output to the set input of the block S7. In all of the remaining cases, if PWM_{count} lies between the thresholds, DIGₒᵤₜ remains unchanged. If the frequency of the input signal Uᵢₙ is so large that no complete measurement time tₘₑₛₛ is available, then no completion signal is generated and one of the blocks S3, S4, or S5 generates an “Invalid” signal via the reset input of the block S8.

The embodiment of FIG. 4 relates to the signals of FIG. 2. For the inverse logic, such as that shown in FIG. 3, the tests in the blocks S1, S3, S4, and S5 are performed with test parameters changed accordingly.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. A circuit arrangement for electrically isolated transmission of an electrical signal with an optocoupler comprising:
a converter circuit which is connected to an input side of the optocoupler and which converts an electrical signal into a pulse width-modulated signal and supplies said pulse width-modulated signal to the optocoupler;
a logic circuit which generates a completion signal and delivers said completion signal to the optocoupler when the conversion into the pulse width-modulated signal has completely finished; and
an evaluation circuit which is connected to the output side of the optocoupler and which recognizes the pulse width-modulated signal as valid only when the completion signal has been received.

2. The circuit arrangement according to claim 1 wherein the completion signal is a double pulse.

3. The circuit arrangement according to claim 1 wherein the conversion into said pulse width-modulated signal is performed only when a predetermined delay time has elapsed after appearance of the electrical signal to be converted.

4. The circuit arrangement according to claim 2 wherein the conversion into said pulse width-modulated signal is performed only when a predetermined delay time has elapsed after appearance of the electrical signal to be converted.

5. The circuit arrangement according to claim 1 wherein the electrical signal is supplied to a power supply unit which receives from the electrical signal a power supply for the convertor circuit, the logic circuit, and a start identification circuit connected to the input side of the optocoupler.

6. The circuit arrangement according to claim 2 wherein the electrical signal is supplied to a power supply unit which receives from the electrical signal a power supply for the convertor circuit, the logic circuit, and a start identification circuit connected to the input side of the optocoupler.

7. The circuit arrangement according to claim 3 wherein the electrical signal is supplied to a power supply unit which receives from the electrical signal a power supply for the convertor circuit, the logic circuit, and a start identification circuit connected to the input side of the optocoupler.

8. The circuit arrangement according to claim 4 wherein the electrical signal is supplied to a power supply unit which receives from the electrical signal a power supply for the convertor circuit, the logic circuit, and a start identification circuit connected to the input side of the optocoupler.

9. The circuit arrangement according to claim 1 wherein said arrangement has a multi-channel structure and delivers the pulse width-modulated signals in a time-interleaved manner to the optocoupler.

10. The circuit arrangement according to claim 2 wherein said arrangement has a multi-channel structure and delivers the pulse width-modulated signals in a time-interleaved manner to the optocoupler.

11. The circuit arrangement according to claim 3 wherein said arrangement has a multi-channel structure and delivers the pulse width-modulated signals in a time-interleaved manner to the optocoupler.

12. The circuit arrangement according to claim 5 wherein said arrangement has a multi-channel structure and delivers the pulse width-modulated signals in a time-interleaved manner to the optocoupler.

13. The circuit arrangement according to claim 10 wherein a signal uniquely identifying each channel is transmitted before the transmission of the pulse width-modulated signals of the individual channels.

14. The circuit arrangement according to claim 11 wherein a signal uniquely identifying each channel is transmitted before the transmission of the pulse width-modulated signals of the individual channels.

15. The circuit arrangement according to claim 12 wherein a signal uniquely identifying each channel is transmitted before the transmission of the pulse width-modulated signals of the individual channels.
